(19) United States
(12) Patent Application Publication
(10) Pub. No.: US 2008/0028079 A1
(43) Pub. Date: Jan. 31, 2008

(54) METHODS AND APPARATUSES FOR INTERFACE NEGOTIATION IN NETWORK MANAGEMENT SYSTEM

(75) Inventors: Li Yang, Shenzhen (CN); Lan Zou, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/836,949

(22) Filed: Aug. 10, 2007

Related U.S. Application Data
(63) Continuation of application No. PCT/CN2006/001926, filed on Aug. 1, 2006.

(30) Foreign Application Priority Data
Aug. 11, 2005 (CN) 200510091232.3

(51) Int. Cl. G06F 15/173; G06F 15/16

(52) U.S. Cl. 709/227; 709/223

(57) ABSTRACT

A method for interface negotiation in a Network Management System (NMS) is disclosed. The method includes: sending by a sending party in an NMS Integration Reference Point (IRP) version information supported by the sending party to a receiving party in the NMS; and acquiring by the receiving party matching IRP version information between the sending party and the receiving party based on IRP version information supported by the receiving party and the IRP version information supported by the sending party. Another method for interface negotiation and apparatuses for interface negotiation in an NMS are disclosed as well. The matching IRP version information can match functional interface IRP, data definition IRP and NRM IRP of a managing unit with those of a managed unit, thus guaranteeing correct interaction between the managing unit and the managed unit, and greatly reducing the influence on the whole NMS after the network is partly updated.

This application is a continuation of International Patent Application No. PCT/CN2006/001926, filed Aug. 1, 2006, which claims priority to Chinese Patent Application No. 200510091232.3, filed Aug. 11, 2005, both of which are hereby incorporated by reference.

### FIELD OF THE INVENTION

The present invention relates to network management technologies, and more particularly, to methods and an apparatuses for interface negotiation in a network management system.

### BACKGROUND OF THE INVENTION

A typical/conventional Network Management System (NMS) includes two logical entities: a managing unit and a managed unit. The managing unit and managed unit intercommunicate with each other via an interaction interface. With the extension of the NMS and its functions, the relationship between the managing unit and the managed unit becomes more and more complicated. There can be a multi-level management relationship between the managing unit and the managed unit, and/or a management relationship between multiple managing units and multiple managed units.

With reference to FIG. 1, the multi-level management relationship includes a managed object, a level 1 manager, a level 2 manager, . . . , and a level N manager. The managed object may be a network element system; the level 1 manager may be a Network Element Management System (EMS); the level 2 manager may be the NMS; while the level N manager may be a multi-level upper-class NMS which is cascaded. In the multi-level management relationship shown in FIG. 1, the level 1 manager, the level 2 manager, . . . , and the level N manager each can serve as a managing unit; and the managed object or the manager with the lower level corresponding to the managing unit can serve as the corresponding managed unit. FIG. 2 shows a management relationship between multiple managing units and multiple managed units. With reference to FIG. 2, managing unit A and managing unit B manage respectively but simultaneously two managed units: managed unit 1 and managed unit 2. Managed unit 1 and managed unit 2 are respectively managed by managing unit A and managing unit B. It can be seen from the above management relationship that, either the EMS or NMS can serve as a managing unit, while either the network element system or EMS can serve as the corresponding managed unit.

The interface between the managing unit and the managed unit includes a functional interface Integration Reference Point (IRP), or further includes a data definition IRP or a Network Resource Model (NRM) IRP. The functional interface IRP can call at least one data definition IRP or at least one NRM IRP. In other words, the functional interface IRP can be associated with at least one data definition IRP or at least one NRM IRP. FIG. 3 is a schematic diagram illustrating an IRP relationship between a managing unit and a managed unit. As shown in FIG. 3, the managing unit supports a functional interface IRP-1, an NRM IRP-2 and a data definition IRP-3. The functional interface IRP-1 of the managing unit supports calling some versions of NRM IRP-2 and data definition IRP-3. In other words, there are a calling relationship between the functional interface IRP-1 version and the NRM IRP-2 version and a calling relationship between the functional interface IRP-1 version and the data definition IRP-3 version. The managed unit supports the functional interface IRP-1, the NRM IRP-2 and the data definition IRP-3. The functional interface IRP-1 of the managed unit supports calling some versions of NRM IRP-2 and data definition IRP-3. In other words, there are a calling relationship between the functional interface IRP-1 version and the NRM IRP-2 version and a calling relationship between the functional interface IRP-1 version the data definition IRP-3 version.

Along with the gradual extension of the network, the interface between the managing unit and the managed unit becomes more and more complicated. Moreover, the managing unit and managed unit may need updating according to using requirements, when used by a network operator. Accordingly, it is a crucial technical question about how to acquire matching IRP version information between the managing unit and managed unit, and how to use the matching IRP correctly to implement interaction operations between the managing unit and managed unit after the managing unit and managed unit are updated.

### SUMMARY OF THE INVENTION

The present invention provides methods and apparatuses for interface negotiation in a Network Management System (NMS) to match the Integration Reference Point (IRP) of the managing unit and the IRP of the managed unit.

The present invention provides a method for interface negotiation in a NMS, the method includes:

sending, by the sending party in an NMS, IRP version information supported by the sending party to a receiving party in the NMS; and

acquiring, by the receiving party, matching IRP version information between the sending party and the receiving party based on IRP version information supported by the receiving party and the IRP version information supported by the sending party.

The sending party may be a managing unit, and the receiving party may be a managed unit.

The sending party may be a managed unit, and the receiving party may be a managing unit.

The present invention also provides an apparatus for interface negotiation in an NMS, includes:

a sending party negotiation module located in a sending party, configured to send IRP version information supported by the sending party; and

a receiving party negotiation module located in a receiving party, configured to receive the IRP version information supported and sent by the sending party, and acquire matching IRP version information between the sending party and the receiving party based on IRP version information supported by the receiving party and the IRP version information supported by the sending party.

The sending party may be a managing unit, and the receiving party may be a managed unit.

The sending party may be a managed unit, and the receiving party may be a managing unit.

The present invention further provides an apparatus for interface negotiation in an NMS, includes:

a unit for obtaining first IRP version information supported by a first network element in an NMS;

a unit for acquiring second IRP version information supported by a second network element in the NMS; and

a unit for determining matching IRP version information between the first network element and the second network element depending on the first IRP version information supported by the first network element and the second IRP version information supported by the second network element.

It can be seen from the method and apparatus in the above solution, the IRP version information supported by the sending party of the managing unit and managed unit is sent to the receiving party of the managing unit and managed unit, and the receiving negotiation module of the receiving party acquires the matching IRP version information between the sending party and the receiving party based on the IRP version information supported by the receiving party and the received IRP version information supported by the sending party. Therefore, the matching IRSP version information can match functional interface IRP, data definition IRP and NRM IRP of the managing unit with functional interface IRP, data definition IRP and NRM IRP of the managed unit, thus guaranteeing correct interaction of the managing unit and the managed unit, and greatly reducing the influence on the whole NMS after the network is partly updated.

### BRIEF DESCRIPTION OF THE DRAWINGS

FIG. 1 is a schematic diagram illustrating architecture with multiple management levels.

FIG. 2 is a schematic diagram illustrating a relationship between multiple managing units and multiple managed units.

FIG. 3 is a schematic diagram illustrating an IRP relationship between a managing unit and a managed unit.

FIG. 4 is a schematic diagram illustrating the structure of an apparatus in accordance with an embodiment of the present invention.

FIG. 5 is a flow chart of a first embodiment in accordance with an embodiment of the present invention.

FIG. 6 is a schematic diagram illustrating a relationship between functional interface IRP versions supported by the managed unit and NRM IRP versions of object sets corresponding to the functional interface IRPs in accordance with a first embodiment of the present invention.

FIG. 7 is a schematic diagram illustrating the relationship between functional interface IRP versions supported by the managing unit and NRM IRP versions of object models corresponding to the functional interface IRPs in accordance with the first embodiment of the present invention.

FIG. 8 is a schematic diagram illustrating the structure of the apparatus in accordance with the first embodiment of the present invention.

FIG. 9 is a schematic diagram illustrating a flow chart in accordance with a second embodiment of the present invention.

FIG. 10 is a schematic diagram illustrating the structure of the apparatus in accordance with the second embodiment of the present invention.

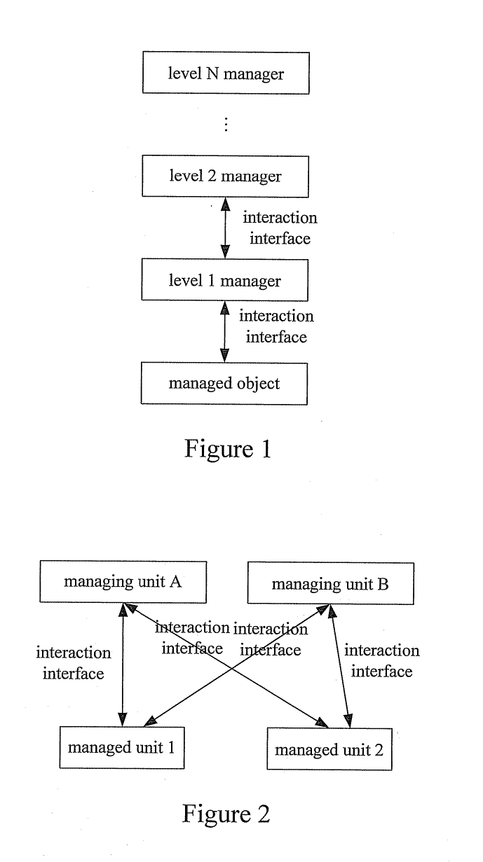

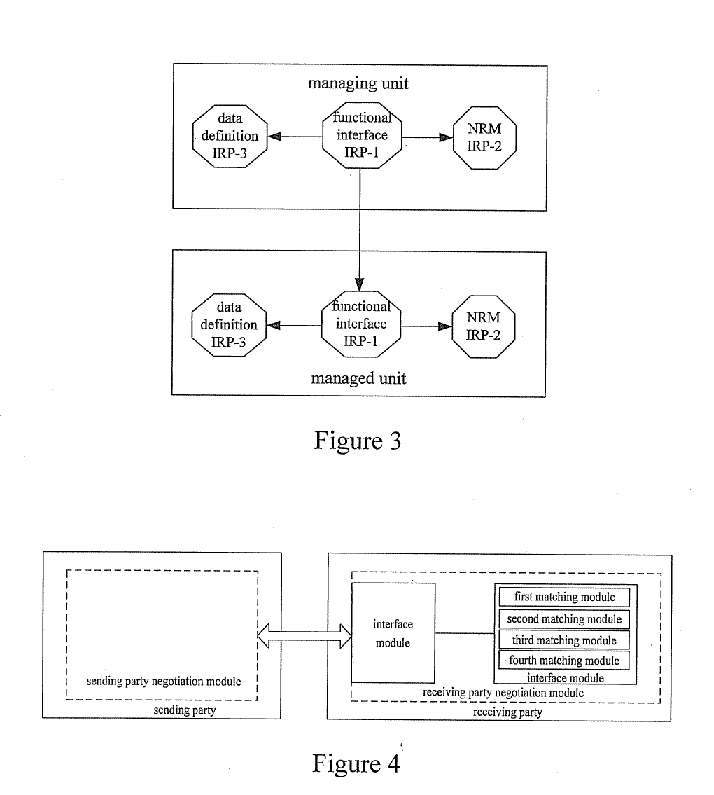

### DETAILED DESCRIPTION OF THE INVENTION

In order to make the technical schemes and merits of the present invention clearer, embodiments of the present invention are hereinafter given.

TABLE 1

| sce- | IRP version Information supported | |
|---|---|---|
| nario | Managing unit | Managed unit |
| 1 | Functional interface IRP | Functional interface IRP |
| | version information | version information |
| 2 | Functional interface IRP | Functional interface IRP |
| | version information; | version information; |
| | Data definition IRP version | Data definition IRP version |
| | information of the object | information of the object |
| | model corresponding to the | set corresponding to the |
| | functional interface IRP | functional interface IRP |
| 3 | Functional interface IRP | Functional interface IRP |
| | version information; | version information; |
| | NRM IRP version information | NRM IRP version information |
| | of the object model | of the object set |
| | corresponding to the | corresponding to the |
| | functional interface IRP | functional interface IRP |
| 4 | Functional interface IRP | Functional interface IRP |
| | version information; | version information; |
| | Data definition IRP version | Data definition IRP version |
| | information of the object | information of the object |
| | model corresponding to the | set corresponding to the |
| | functional interface IRP; | functional interface IRP; |
| | NRM IRP version information | NRM IRP version information |
| | of the object model | of the object set |
| | corresponding to the | corresponding to the |
| | functional interface IRP | functional interface IRP |

Referring to Table 1, as shown in scenario 1, the IRP version information supported by the managing unit and the IRP version information supported by the managed unit may include only functional interface IRP version information. In scenario 2 of the Table 1, the IRP version information supported by the managing unit may include functional interface IRP version information and data definition IRP version information of the object set corresponding to the functional interface IRP. The IRP version information supported by the managed unit may include functional interface IRP version information and data definition IRP version information of the object module corresponding to the functional interface IRP. In scenario 3 of the Table 1, the IRP version information supported by the managing unit may include Functional interface IRP version information and NRM: IRP version information of the object model corresponding to the functional interface IRP. The IRP version information supported by the managed unit may include Functional interface IRP version information and NRM IRP version information of the object set corresponding to the functional interface IRP. In scenario 4 of the Table 1, the IRP version information supported by the managing unit may include Functional interface IRP version information, data definition IRP version information of the object model corresponding to the functional interface IRP, and NRM IRP version information of the object model corresponding to the functional interface IRP. The IRP version information supported by the managed unit may include Functional interface IRP version information, data definition IRP version information of the object set corresponding to the functional interface IRP, and NRM IRP version information of the object set corresponding to the functional interface IRP.

According to the embodiment of the present invention, the managing unit and managed unit may respectively serve as a sending party and a receiving party, or a receiving party and a sending party. During the procedure of interface negotiation, the sending party sends the IRP version information supported by the sending party to the receiving party and the receiving party acquires matching IRP version information between the sending party and the receiving party base on the IRP version information supported by the receiving party and the received IRP version information supported by the sending party.

As shown in FIG. 4, the apparatus in accordance with the embodiment of the present invention includes a sending party negotiation module located in the sending party and a receiving party negotiation module located in the receiving party. The sending party negotiation module is configured to send the IRP version information supported by the sending party to the receiving party. The receiving party negotiation module is configured to receive the IRP version information supported and sent by the sending party and acquire the matching IRP version information between the sending party and the receiving party based on the IRP version information supported by the receiving party and the IRP version information supported by the sending party.

The receiving party negotiation module may include an interface module and a matching module. The interface module is configured to receive the IRP version information supported and sent by the sending party and forwarding the IRP version information supported by the sending party to the matching module. The matching module is configured to acquire the matching IRP version information between the sending party and the receiving party based on the IRP version information supported by the receiving party and the IRP version information supported by the sending party.

In dependence on different IRP version information supported by the managing unit and the managed unit, the matching module may further include different matching modules: a first matching module, a second matching module, a third matching module and a fourth matching module. The first matching module is configured to acquire the matching IRP version information between the managing unit and the managed unit based on the IRP version information supported by the managing unit and the IRP version information supported by the managed unit in accordance with the scenario 1 in Table 1. The second matching module is configured to acquire the matching IRP version information between the managing unit and the managed unit based on the IRP version information supported by the managing unit and the IRP version information supported by the managed unit in accordance with the scenario 2 in Table 1. The third matching module is configured to acquire the matching IRP version information between the managing unit and the managed unit based on the IRP version information supported by the managing unit and the IRP version information supported by the managed unit in accordance with the scenario 3 in Table 1. The fourth matching module is configured to acquire the matching IRP version information between the managing unit and the managed unit based on the IRP version information supported by the managing unit and the IRP version information supported by the managed unit in accordance with the scenario 4 in Table 1.

According to a first embodiment of the present invention, the sending party is the managed unit and the receiving party is the managing unit. The receiving party, i.e., the managing unit, acquires the matching IRP version information between the managing unit and the managed unit based on the IRP version information supported by the managing unit and the IRP version information supported by the managed unit. In the first embodiment, scenario 3 in Table 1 is taken as an example.

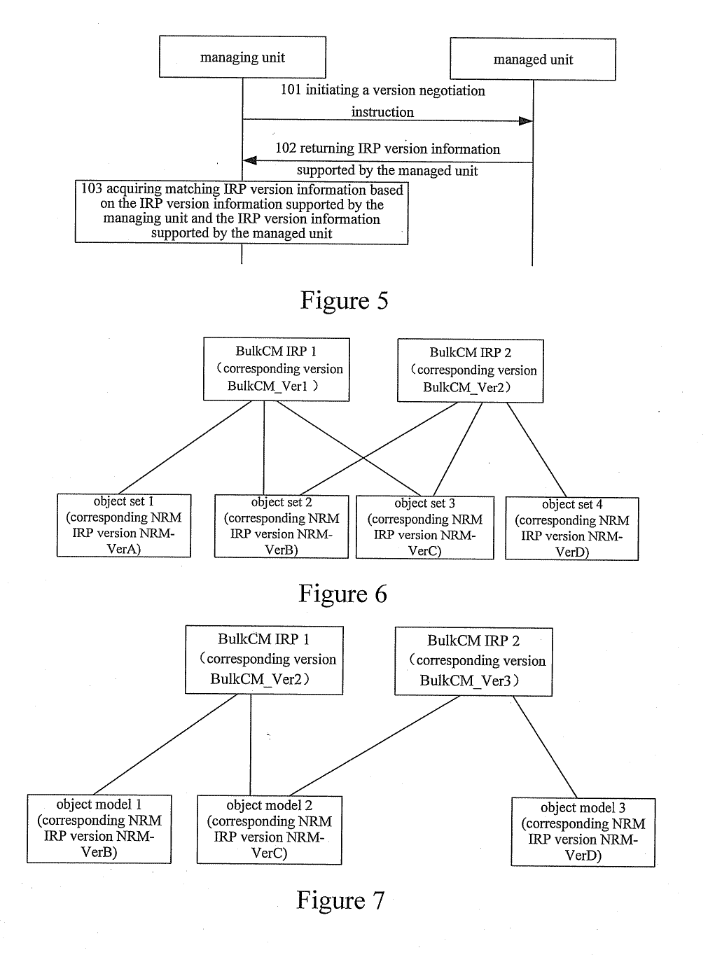

As shown in FIG. 5, a method according to the first embodiment includes:

In 101: A managing unit sends a version negotiation instruction to a managed unit.

In 102: In response to receiving the version negotiation instruction sent by the managing unit, the managed unit sends IRP version information supported by the managed unit to the managing unit according to the version negotiation instruction.

The IRP version information supported by the managed unit includes the functional interface IRP version information and NRM IRP version information of the object set corresponding to the functional interface IRP. The managed unit may send the functional interface IRP version information and NRM IRP version information of the object set corresponding to the functional interface IRP to the managing unit simultaneously. Also, the managed unit may send the functional interface IRP version information and NRM IRP version information of the object set corresponding to the functional interface IRP to the managing unit one by one.

In 103: The managing unit acquires the matching IRP version information between the managing unit and the managed unit based on the IRP version information supported by the managing unit and the IRP version information supported by the managed unit, upon receiving the IRP version information supported and sent by the managed unit.

Apparatus of different manufactures may adopt different schemes to acquire the matching IRP version information between the managing unit and the managed unit based on the IRP version information supported by the managing unit and the IRP version information supported by the managed unit. Hereinafter one scheme for acquiring the matching IRP version information between the managing unit and the managed unit is described as an example.

FIG. 6 shows the functional interface IRP version information and the NRM IRP version information of object sets corresponding to the functional interface IRPs supported by the managed unit.

With reference to Table 2, the functional interface IRPs supported by the managed unit include BulkCM IRP1 and BulkCM IRP2. The BulkCM IRP1 version information is presented by BulkCM_Ver1. The NRM IRP version information of object sets corresponding to the BulkCM IRP1 includes NRM_VerA of object set 1, NRM_VerB of object set 2, and NRM_VerC of object set 3. The BulkCM IRP2 version information is presented by BulkCM_Ver2. The NRM IRP version information of object sets corresponding to the BulkCM IRP2 includes NRM_VerB of object set 2, NRM_VerC of object set 3 and NRM_VerD of object set 4.

TABLE 2

| Functional | Version | NRM IRP of an object | Version |
|---|---|---|---|
| interface IRP | information | set | information |
| BulkCM IRP1 | BulkCM_Ver1 | Object set 1 | NRM_VerA |
| | | Object set 2 | NRM_VerB |
| | | Object set 3 | NRM_VerC |
| BulkCM IRP2 | BulkCM_Ver2 | Object set 2 | NRM_VerB |
| | | Object set 3 | NRM_VerC |
| | | Object set 4 | NRM_VerD |

FIG. 7 shows the functional interface IRP version information and the NRM IRP version information of object models corresponding to the functional interface IRPs supported by the managing unit, wherein the object models are adapted to the object sets of the managed unit.

Referring to Table 3, the functional interface IRPs supported by the managing unit include BulkCM IRP1 and BulkCM IRP2. The BulkCM IRP1 version information is presented by BulkCM_Ver2. The NRM IRP version information of object models corresponding to the BulkCM IRP1 includes NRM_VerB of object model 1 and NRM_VerC of object model 2. The BulkCM IRP2 version information is presented by BulkCM_Ver3. The NRM IRP version information of object models corresponding to the BulkCM IRP2 includes NRM_VerC of object model 2 and NRM_VerD of object model 3.

TABLE 3

| Functional | Version | NRM IRP of an object | Version |
|---|---|---|---|
| interface IRP | information | model | information |
| BulkCM IRP1 | BulkCM_Ver2 | Object model 1 | NRM_VerB |
| | | Object model 2 | NRM_VerC |
| BulkCM IRP2 | BulkCM_Ver3 | Object model 2 | NRM_VerC |
| | | Object model 3 | NRM_VerD |

The managing unit compares the IRP version information supported by the managing unit and the managed unit to acquire the matching IRP version information between the managing unit and the managed unit according to a pre-set matching principle, and takes the IRP version information supported by both the managing unit and managed unit as the matching IRP version information between the managing unit and the managed unit. For example, the managing unit takes the same IRP version information as the matching IRP version information between the managing unit and the managed unit. A s shown in Table 4, the same IRP version information includes: BulkCM_Ver2, which is functional interface IRP version information, NRM_VerB and NRM_VerC which are version information corresponding to the NRM IRP of the object set and object model corresponding to the functional interface IRP. Therefore, the managing unit and managed unit can intercommunicate with each other using BulkCM_Ver2 of BulkCM IRP and NRM_VerB when the managing unit and managed unit are objects within the object set 2, and/or, using BulkCM_Ver2 of BulkCM IRP and NRM_VerC when the managing unit and managed unit are objects within the object set 3.

TABLE 4

| IRP | Version information |
|---|---|
| BulkCM IRP | BulkCM_Ver2 |
| Object set 2 corresponding to object model 1 | NRM_VerB |
| Object set 3 corresponding to object model 2 | NRM_VerC |

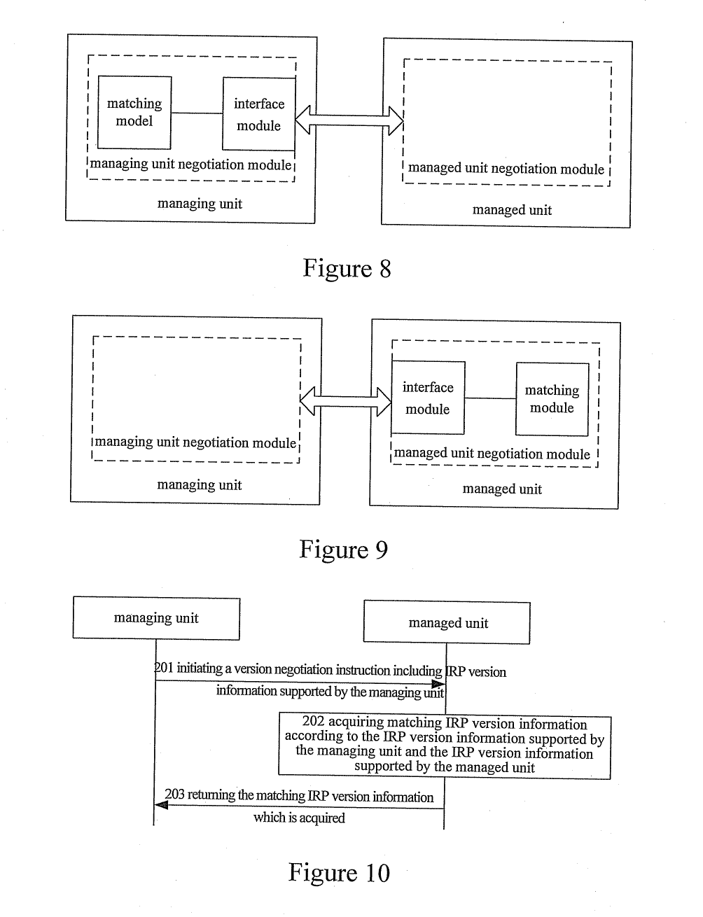

The above method described in the first embodiment of the present invention may be implemented by the apparatus shown in FIG. 8. With reference to FIG. 8, the apparatus may include a managing unit negotiation module located in the managing unit and a managed unit negotiation module located in the managed unit.

The managing unit negotiation module is configured to send a version negotiation instruction to the managed unit, receive IRP version information supported and sent by the managed unit, and acquire matching IRP version information between the managing unit and the managed unit based on the IRP version information supported by the managing unit and the IRP version information supported and sent by the managed unit.

The managing unit negotiation module may include an interface module and a matching module which connect to each other. The interface module is configured to send the version negotiation instruction to the managed unit, receive the IRP version information supported and sent by the managed unit, and forward the received IRP version information to the matching module. The matching module is configured to acquire the matching IRP version information between the managing unit and the managed unit based on the IRP version information supported by the managing unit and the IRP version information supported and sent by the managed unit. The matching module may include a third matching module configured to acquire the matching IRP version information between the managing unit and the managed unit based on the IRP version information supported by the managing unit and the IRP version information supported by the managed unit, as the IRP version information supported by the managing unit and the IRP version information supported by the managed unit are based on the scenario 3 in Table 1.

The managed unit negotiation module located in the managed unit is configured to receive the version negotiation instruction sent by the managing unit and to send the IRP version information supported by the managed unit to the managing unit according to the version negotiation instruction.

In a second embodiment of the present invention, the sending party is the managing unit and the receiving party is the managed unit. The managed unit acquires the matching IRP version information between the managing unit and the managed unit based on related information. In the second embodiment, the scenario 3 in Table 1 is taken as an example.

As shown in FIG. 9, a method according to the second embodiment includes:

In 201: A managing unit sends to a managed unit a version negotiation instruction carrying IRP version information supported by the managing unit.

In 202: In response to receiving the version negotiation instruction from the managing unit, the managed unit acquires the matching IRP version information between the managing unit and the managed unit based on the IRP version information supported by the managed unit and the IRP version information supported by the managing unit carried in the version negotiation instruction.

Apparatus of different manufactures may adopt different schemes to acquire the matching IRP version information between the managing unit and the managed unit based on the IRP version information supported by the managing unit and the IRP version information supported by the managed unit. The matching IRP version information between the managing unit and the managed unit may be acquired in the second embodiment using a similar scheme as that of the first embodiment which will not be detailed here.

In 203: The managed unit may further send the matching IRP version information between the managing unit and the managed unit to the managing unit.

The method according to the second embodiment can be implemented using the apparatus shown in FIG. 10. With reference to FIG. 10, the apparatus includes a managing unit negotiation module located in the managing unit, and a managed unit negotiation module located in the managed unit.

The managing unit negotiation module is configured to send to the managed unit a version negotiation instruction carrying IRP version information supported by the managing unit.

The managed unit negotiation module located in the managed unit is configured to receive the version negotiation instruction sent by the managing unit; acquire the matching IRP version information between the managing unit and the managed unit based on the IRP version information supported and sent by the managed unit and the received IRP version information supported by the managing unit. The managed unit negotiation module may be further configured to send the matching IRP version information between the managing unit and the managed unit to the managing unit negotiation module located in the managing unit.

The managed unit negotiation module may further include an interface module and a matching module which connect to each other. The interface module is configured to receive the version negotiation instruction sent by the managing unit, and forward the IRP version information supported by the managing unit to the matching module. The matching module is configured to acquire the matching IRP version information between the managing unit and the managed unit based on the IRP version information supported and sent by the managed unit and the received IRP version information supported by the managing unit. The matching module may be further configured to send the matching IRP version information between the managing unit and the managed unit to the interface module; then the interface module sends the matching IRP version information between the managing unit and the managed unit to the managing unit negotiation module located in the managing unit. The matching module may further include a third matching module configured to acquire the matching IRP version information between the managing unit and the managed unit based on the IRP version information supported by the managing unit and the IRP version information supported by the managed unit, as the IRP version information supported by the managing unit and the IRP version information supported by the managed unit are based on the scenario 3 in Table 1.

The present invention is described above with reference to particular embodiments, and it will be readily apparent to those skilled in the art that it is possible to embody the present invention in forms other than those described above. The particular embodiments described above are merely illustrative and should not be considered restrictive in any way. The scope of the present invention is determined by the following claims, and, all variations, modifications and equivalents that fall within the range of the claims are intended to be embraced therein.

We claim:

1. A method for interface negotiation in a Network Management System (NMS), comprising:
sending, by a sending party in an NMS, Integration Reference Point (IRP) version information supported by the sending party to a receiving party in the NMS; and
acquiring, by the receiving party, matching IRP version information between the sending party and the receiving party, based on IRP version information supported by the receiving party and the IRP version information supported by the sending party.

2. The method of claim 1, wherein the IRP version information supported by the sending party comprises functional interface IRP version information; and
the IRP version information supported by the receiving party comprise functional interface IRP version information.

3. The method of claim 2, wherein the IRP version information supported by the sending party further comprises data definition IRP version information; and
the IRP version information supported by the receiving party further comprise data definition IRP version information.

4. The method of claim 2, wherein the IRP version information supported by the sending party further comprises Network Resource Model (NRM) IRP version information; and
the IRP version information supported by the receiving party further comprises NRM IRP version information.

5. The method of claim 3, wherein the IRP version information supported by the sending party further comprises NRM IRP version information; and
the IRP version information supported by the receiving party further comprises NRM IRP version information.

6. The method of claim 1, wherein the acquiring the matching IRP version information between the sending party and the receiving party comprises:
acquiring, by the receiving party, the matching IRP version information between the sending party and the receiving party by comparing the IRP version information supported by the receiving party and the IRP version information supported by the sending party based on a pre-set matching principle.

7. The method of claim 6, wherein the acquiring the matching IRP version information between the sending party and the receiving party by comparing the IRP version information supported by the receiving party and the IRP version information supported by the sending party based on the pre-set matching principle comprises:
comparing, by the receiving party, the IRP version information supported by the receiving party and the IRP version information supported by the sending party, and taking IRP version information supported by both the receiving party and the sending party as the matching IRP version information between the sending party and the receiving party.

8. The method of claim 1, wherein the sending party is a managed unit in the NMS and the receiving party is a managing unit in the NMS,
and before sending the IRP version information supported by the sending party to the receiving party the method further comprises:
sending, by the managing unit, a version negotiation instruction to the managed unit.

9. The method of claim 1, wherein the sending party is a managing unit in the NMS and the receiving party is a managed unit in the NMS,
the sending by the sending party the IRP version information supported by the sending party to the receiving party comprises:
sending, by the managing unit, the IRP version information supported by the managing unit to the managed unit via a version negotiation instruction.

10. The method of claim 9, further comprising:
sending, by the managed unit, the matching IRP version information between the sending party and the receiving party to the managing unit.

11. An apparatus for interface negotiation in a Network Management System (NMS), comprising:
a sending party negotiation module located in a sending party in an NMS, the sending party negotiation module being configured to send Integration Reference Point (IRP) version information supported by the sending party to a receiving party in the NMS; and
a receiving party negotiation module located in the receiving party, the receiving party negotiation module being configured to receive the IRP version information supported and sent by the sending party and acquire matching IRP version information between the sending party and the receiving party based on IRP version information supported by the receiving party and the IRP version information supported by the sending party.

12. The apparatus of claim 11, wherein the receiving party negotiation module comprises an interface module and a matching module; wherein
the interface module is configured to receive the IRP version information supported and sent by the sending party and forward the received IRP version information supported by the sending party to the matching module; and
the matching module is configured to receive the IRP version information supported by the sending party from the interface module, and acquire the matching IRP version information between the sending party and the receiving party based on IRP version information supported by the receiving party and the IRP version information supported by the sending party.

13. The apparatus of claim 11, wherein the sending party is a managing unit in the NMS and the receiving party is a managed unit in the NMS,
the receiving party negotiation module is further configured to send the matching IRP version information between the sending party and the receiving party to the sending party negotiation module.

14. The apparatus of claim 11, wherein the sending party is a managed unit in the NMS, and the receiving party is a managing unit in the NMS,
the receiving party negotiation module is further configured to send a version negotiation instruction to the sending party negotiation module, and
the sending party negotiation module sends the IRP version information supported by the sending party to the receiving party negotiation module according to the version negotiation instruction.

15. An apparatus for interface negotiation in a Network Management System (NMS), comprising:
a unit for obtaining first Integration Reference Point (IRP) version information supported by a first network element in an NMS;
a unit for acquiring second IRP version information supported by a second network element in the NMS; and
a unit for determining matching IRP version information between the first network element and the second network element depending on the first IRP version information supported by the first network element and the second IRP version information supported by the second network element.

16. A method for interface negotiation in a Network Management System (NMS), comprising:
obtaining first Integration Reference Point (IRP) version information supported by a managing device in an NMS;
acquiring second IRP version information supported by a managed device in the NMS; and
determining matching IRP version information between the managing unit and the managed unit depending on the first IRP version information supported by the managing device and the second IRP version information supported by the managed device.

17. The method of claim 16, wherein the determining the matching IRP version information between the managing unit and the managed unit comprises:
determining the matching IRP version information between the managing unit and the managed unit by comparing the first IRP version information supported by the managing device and the second IRP version information supported by the managed device based on a pre-set matching principle.

18. The method of claim 17, wherein the determining the matching IRP version information between the managing unit and the managed unit by comparing the first IRP version information supported by the managing device and the second IRP version information supported by the managed device based on the pre-set matching principle comprises:
comparing the first IRP version information supported by the managing device and the second IRP version information supported by the managed device, and taking IRP version information supported by both the managing device and the managed device as the matching IRP version information between the managing unit and the managed unit.

19. The method of claim 16, wherein the determining is implemented by the, managed device.

20. The method of claim 19, wherein the obtaining the first IRP version information supported by the managing device in the NMS comprises:
receiving, by the managed device, the first IRP version information supported and sent by the managing device.

21. The method of claim 16, wherein the determining is implemented by the managing device.

22. The method of claim 21, wherein the acquiring second IRP version information supported by the managed device in the NMS comprises:
sending, by the managing device, a version negotiation instruction to the managed unit;
receiving, by the managing device, the second IRP version information supported by the managed device sent by the managed device based on the version negotiation instruction.
